(19) United States
(12) Patent Application Publication
(10) Pub. No.: US 2018/0212860 A1
(43) Pub. Date: Jul. 26, 2018

(54) AUTOMATICALLY DETECTING POTENTIAL MICROLOOP CONDITIONS ASSOCIATED WITH NETWORK CONVERGENCE

(71) Applicant: LinkedIn Corporation, Sunnyvale, CA (US)

(72) Inventors: Russell I. White, Apex, NC (US); Shafagh Zandi, San Francisco, CA (US); Zaid A. Kahn, San Francisco, CA (US)

(73) Assignee: LinkedIn Corporation, Sunnyvale, CA (US)

(21) Appl. No.: 15/411,451

(22) Filed: Jan. 20, 2017

(51) Int. Cl. H04L 12/751; H04L 12/705; H04L 12/933; H04L 12/733

(52) U.S. Cl. CPC H04L 45/02; H04L 45/20; H04L 49/102; H04L 45/18

(57) ABSTRACT

The disclosed embodiments provide a system that automatically detects a potential microloop condition associated with network convergence. During operation, the system obtains a topology for a network containing a set of nodes connected by a set of links. Next, the system uses the topology to detect a ring containing at least four hops in the network. The system then outputs an indication of a potential microloop condition associated with one or more nodes on the ring to improve improve routing of network traffic by the one or more nodes.

### BACKGROUND

### Field

The disclosed embodiments relate to link state protocols in networks. More specifically, the disclosed embodiments relate to techniques for automatically detecting potential microloop conditions associated with network convergence.

### Related Art

Link state protocols are commonly used in packet-switched networks to convey connectivity information among nodes in the networks. In turn, the connectivity information may be used by the nodes to construct network topologies of the networks and corresponding routing tables containing paths to destinations in the networks.

When a change in connectivity is detected in a network, the change is flooded in a link state message from the node that detected the change to all other nodes in the same flooding domain of the network. If the change in connectivity includes a link or node failure in a topological ring that is larger than three hops, a “microloop” may occur during subsequent convergence of the network. As shown in the exemplary ring topology of FIG. 1, a failure in the link between nodes A 102 and B 104 may cause A to calculate a new best path to destination X 112 through node C 106. However, C may learn of the failed link only after receiving a link state message communicating the failure from A. Because C continues to use A as the best path to B until C calculates a new best path to B, network traffic from A to B may temporarily loop between A and C during the period between the best path calculations of A and C. In turn, the microloop between A and C may delay forwarding of packets to B and/or result in packet loss between A and B.

Consequently, use of networks with link state protocols may be improved by averting microloop conditions during convergence of the networks.

### BRIEF DESCRIPTION OF THE FIGURES

FIG. 1 shows an exemplary ring topology for a network in accordance with the disclosed embodiments.

FIG. 2 shows a system for detecting a potential microloop condition associated with network convergence in accordance with the disclosed embodiments.

FIG. 3 shows a flowchart illustrating a process of detecting a potential microloop condition associated with network convergence in accordance with the disclosed embodiments.

FIG. 4 shows a flowchart illustrating a process of detecting a ring containing at least four hops in a topology of a network in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

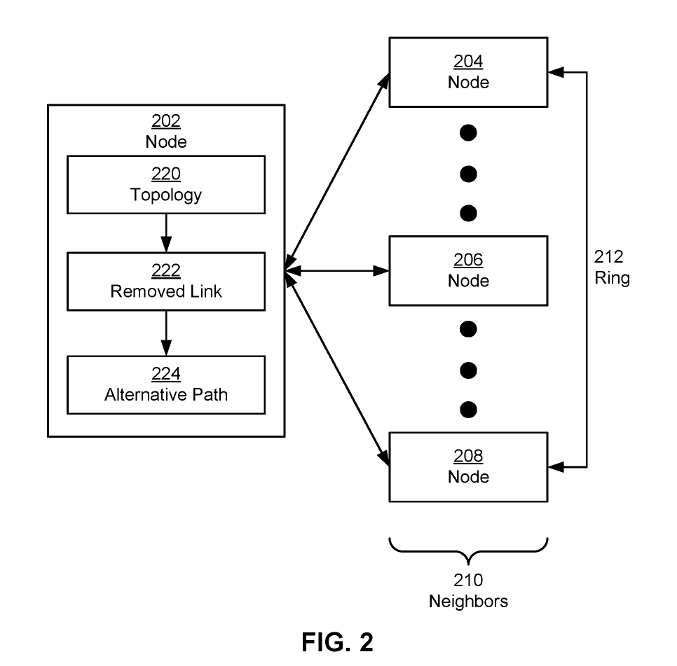

The disclosed embodiments provide a method, apparatus, and system for improving the use of networks with link state protocols. More specifically, the disclosed embodiments provide a method, apparatus, and system for automatically detecting potential microloop conditions associated with network convergence using link state protocols. As shown in FIG. 2, a node 202 in a network may have a set of neighbors 210 represented by other nodes 204-208 that are directly connected to node 202.

Nodes 202-208 may be network elements in a packet-switched network. For example, the nodes may include switches, routers, and/or other switching nodes in a local area network (LAN), wide area network (WAN), personal area network (PAN), virtual private network, intranet, mobile phone network (e.g., a cellular network), WiFi network, Bluetooth network, universal serial bus (USB) network, Ethernet network, and/or switch fabric. Within the network, pairs of nodes may be connected via one or more physical and/or virtual links in a topology 220 such as a leaf-spine topology, fat tree topology, Clos topology, mesh topology, “hypercube” topology, and/or star topology.

Each node in the network may use a link state protocol such as Open Shortest Path First (OSPF) and/or Intermediate System to Intermediate System (IS-IS) to identify neighbors of the node and/or construct topology 220. The node may then use the identified neighbors and/or constructed topology to generate routes to other nodes in the network. For example, node 202 may select links with nodes 204-208 as best paths for transmitting packets to nodes 204-208 and/or destinations connected to nodes 204-208.

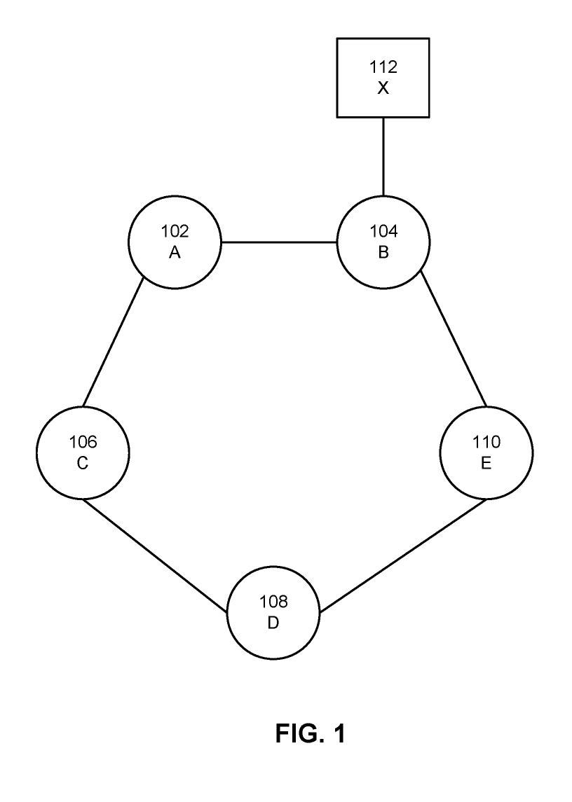

When a link between node 202 and a neighboring node fails, the node may be required to recalculate a best path to the neighbor and/or a destination connected to the neighbor through other nodes and links in the network. However, failures in nodes or links that reside on rings of four or more hops may result in microloops that delay or drop network traffic during subsequent convergence of the network. Using the exemplary topology of FIG. 1, a failed link between node A 102 and node B 104 may be immediately detected by A. In turn, A floods a link state message communicating the failure to other nodes in the network and initiates the recalculation of a best path toward destination X 112 through nodes C 106, D 108, and E 110 instead of through the failed link with B. On the other hand, C does not initiate the best path recalculation until C receives the link state message from A. Thus, C may continue using A as the best path toward X during the delay between the best path recalculation at A and the best path recalculation at C, resulting in a temporary microloop of network traffic destined for X between A and C until the network converges.

In one or more embodiments, the system of FIG. 2 includes functionality to automatically detect potential microloop conditions in the network, thereby facilitating prevention of microloops during convergence of the network. A potential microloop condition may be found when a failure in a node or link in the network can result in a microloop during converging of the network in response to the failure, as described above with respect to the exemplary topology of FIG. 1.

In particular, one or more nodes in the network may act as node 202 and use topology 220 to identify one or more portions of the network that are susceptible to the potential microloop condition. First, the node may update the topology with a removed link 222 between the node and another node in the set of neighbors 210 of the node. For example, the node may remove the link from a link state database on the node before constructing the topology from remaining link state advertisements (LSAs) in the link state database.

Next, node 202 may calculate, based on the modified topology 220 with removed link 222, an alternative path 224 between the two nodes previously connected by the removed link. If one or more alternative paths exist, the node may identify a ring 212 that contains both nodes. For example, node 202 may search the topology for paths connecting node 202 with node 204, after the link between the two nodes is removed from the topology. In turn, the node may identify a ring 212 containing both nodes from an alternative path that connects the two nodes through node 208.

Node 202 may then establish a potential microloop condition associated with ring 212 based on the number of hops in alternative path 224. If any alternative path between the two nodes contains more than two hops, the ring may contain four or more hops, and a microloop may develop if a link or node in the ring fails. Referring to the exemplary topology of FIG. 1, node A 102 may remove a link with node C 106 and calculate an alternative path to C through nodes B 104, E 110, and D 108. Because the alternative path has four hops, A may identify a ring with five hops that contains both A and C and, in turn, a potential microloop condition associated with nodes in the ring.

Once a potential microloop condition is found, node 202 and/or another component of the system may output an indication of the potential microloop. For example, the component may flag all nodes or links on the ring as candidates for protection from microloops. In another example, the component may transmit indications of the potential microloop to nodes on the ring and/or an administrator of the network. Continuing with the exemplary topology of FIG. 1, the component may generate metadata labeling all five nodes 102-110 in the ring as having the potential microloop condition, transmit the labels in messages to the nodes, and/or transmit the labels in alerts to the administrator and/or a centralized controller.

In turn, nodes on the ring may obtain one or more loop-free alternate (LFA) paths to other nodes in the ring and store the LFA paths as backup paths to the other nodes. For example, the nodes may use fast reroute and/or other microloop protection techniques to calculate local and/or remote LFAs as backup paths to other nodes in the ring. When the failure of a link or node on the ring is subsequently detected, remaining nodes on the ring may use the backup paths to route network traffic to other nodes on the ring, thereby averting microloops during network convergence after the failure. By automatically implementing microloop protection features in response to detected potential microloop conditions in the network, the nodes may reduce overhead associated with manually identifying the potential microloop condition in topology 220 and subsequently configuring individual nodes that are susceptible to microloops with microloop protection features.

Node 202 and/or other components of the system may repeat the process with other links in topology 220. For example, each node in the network may operate as node 202 and remove individual links with neighbors 210 in the topology to detect potential microloop conditions in rings with four or more hops that contain the node. Alternatively, a subset of nodes in the network and/or a centralized controller may identify all rings with four or more hops in the network by systematically removing individual links from pairs of nodes in the topology and identifying alternative paths between the nodes using remaining links in the topology. In turn, nodes on the identified rings may be notified of the potential microloop conditions and use microloop protections to avoid or mitigate traffic delays or loss during convergence of the network.

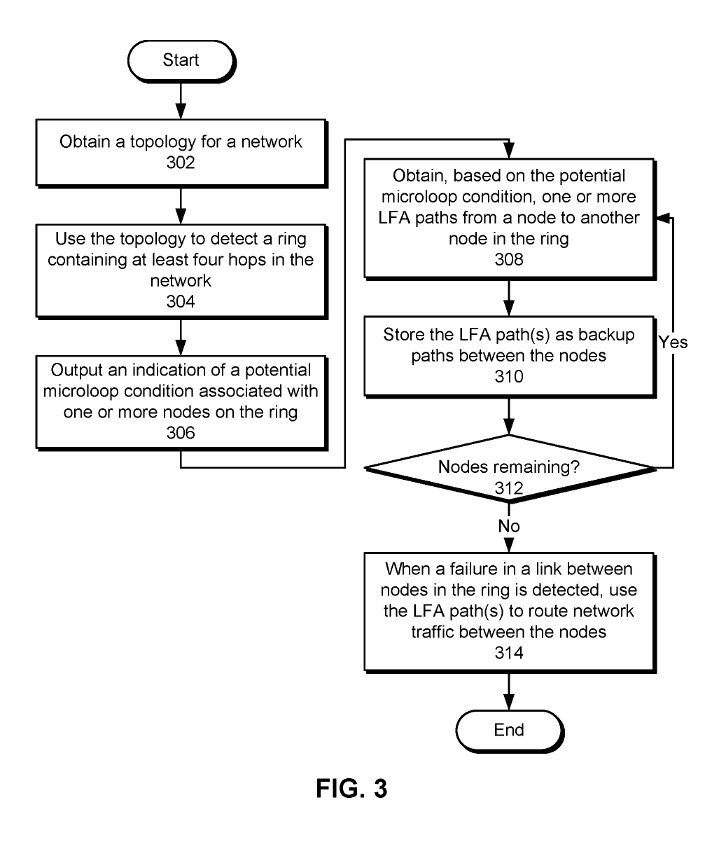

FIG. 3 shows a flowchart illustrating a process of detecting a potential microloop condition associated with network convergence in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

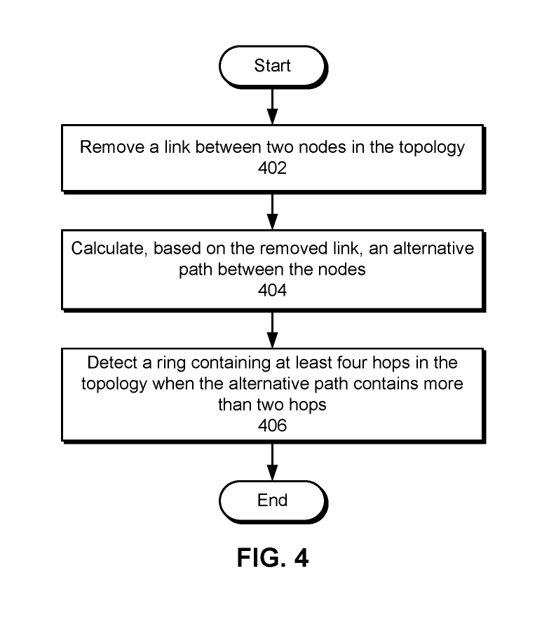

Initially, a topology for a network is obtained (operation 302). For example, the topology may be constructed from LSAs and/or other messages communicated among nodes of the network using a link state protocol and/or other routing protocol. Next, the topology is used to detect a ring containing at least four hops in the network (operation 304), as described in further detail below with respect to FIG. 4. An indication of a potential microloop condition associated with one or more nodes on the ring is then outputted (operation 306) to improve routing of network traffic by the node(s). For example, all nodes on the ring may be assigned and/or flagged with the potential microloop condition to allow an administrator to configure the nodes with microloop protections. In another example, the nodes may be notified of the potential microloop condition to allow the nodes to enable microloop protections without requiring administrative intervention.

More specifically, the outputted indication allows a given node on the ring to obtain, based on the potential microloop condition, one or more LFA paths from the node to another node in the ring (operation 308). For example, the node may use a fast reroute protection technique to calculate one or more local or remote LFAs for a protected link between the node and the other node. Next, the node stores the LFA path(s) as backup paths between the two nodes (operation 310). For example, local and/or remote LFAs obtained in operation 308 may be stored in a routing table in the node.

Operations 308-310 may be repeated for remaining nodes (operation 312) in the ring. As a result, the nodes may include functionality to use notifications or indications of the potential microloop condition to automatically enact microloop protection features instead of requiring an administrator to manually identify the potential microloop condition and configure individual nodes in the ring with the microloop protection features.

Finally, when a failure in a link between nodes in the ring is detected, the LFA path(s) are used to route network traffic between the nodes (operation 314). For example, the LFA path(s) may be used by remaining nodes in the ring to route packets in the absence of the link, thereby avoiding microloops between pairs of the remaining nodes during convergence of the network after the failure.

FIG. 4 shows a flowchart illustrating a process of detecting a ring containing at least four hops in a topology of a network in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

First, a link is removed between two nodes in the topology (operation 402). For example, a node in the network may remove, from a routing database and/or a copy of the routing database at the node, the link between the node and a neighbor in the topology. Alternatively, the node may remove a link between two other nodes in the network. Next, an alternative path between the nodes is calculated based on the removed link (operation 404). For example, the alternative path may be identified by using a pathfinding technique to search a graph-based representation of the topology with the removed link. Because the alternative path connects the nodes in the absence of the link, the alternative path may represent an LFA path between the nodes.

Finally, a ring containing at least four hops in the topology is detected when the alternative path contains more than two hops between the nodes (operation 406). For example, an alternative path with three hops between the nodes may be combined with the removed link between the nodes to form a ring with four hops. In turn, the detected ring may be used to indicate a potential microloop condition and/or prevent microloops in the network, as discussed above.

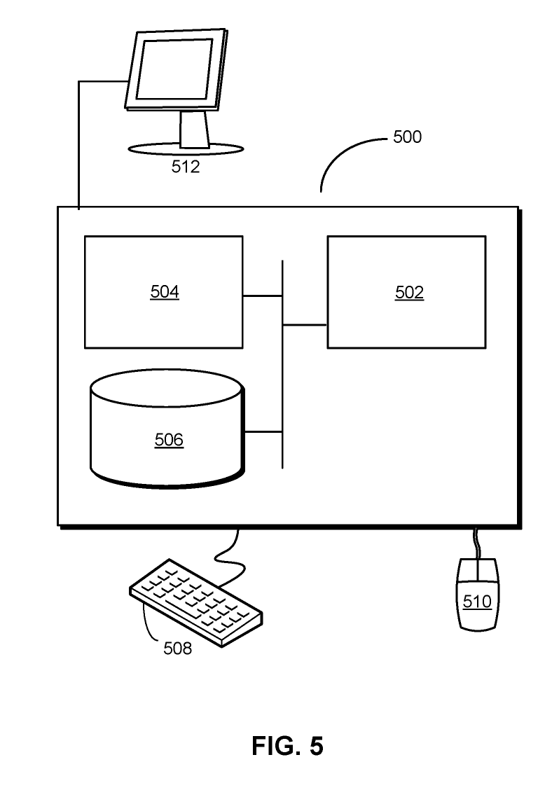

FIG. 5 shows a computer system 500. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for automatically detecting a potential microloop condition in a network. The system may obtain a topology for the network and use the topology to detect a ring containing at least four hops in the network. To detect the ring, the system may remove a link between two nodes in the topology and calculate, based on the removed link, an alternative path between the nodes. When the alternative path includes more than two hops, a ring with at least four hops is found. Finally, the system may output an indication of a potential microloop condition associated with one or more nodes on the ring to improve routing of network traffic by the node(s).

In addition, one or more components of computer system 500 may be remotely located and connected to the other components over a network. Portions of the present embodiments may also be located on different nodes of a distributed system that implements the embodiments. For example, the present embodiments may be implemented using a cloud computing system that automatically detects a potential microloop condition in a remote network and outputs the potential microloop condition to nodes in the network to which the potential microloop condition pertains.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a topology for a network comprising a set of nodes connected by a set of links;
using the topology to detect, by a node in the set of nodes, a ring comprising at least four hops in the network; and
outputting an indication of a potential microloop condition associated with one or more nodes on the ring to improve routing of network traffic by the one or more nodes.

2. The method of claim 1, wherein using the topology to detect the ring comprises:
removing a link between the node and another node in the topology;
calculating, based on the removed link, an alternative path between the node and the other node; and
detecting the ring when the alternative path comprises more than two hops.

3. The method of claim 2, wherein the alternative path comprises a loop-free alternate (LFA) path between the node and the other node.

4. The method of claim 1, further comprising:
obtaining, based on the potential microloop condition, one or more loop-free alternate (LFA) paths from the node to another node on the ring; and
storing the one or more LFA paths as backup paths between the node and the other node.

5. The method of claim 4, further comprising:
when a failure in a link between the node and the other node is detected, using the one or more LFA paths to route network traffic between the node and the other node.

6. The method of claim 5, wherein the one or more LFA paths comprise at least one of:
a local LFA; and
a remote LFA.

7. The method of claim 1, wherein outputting the indication of the potential microloop condition comprises:
assigning the potential microloop condition to all nodes on the ring.

8. The method of claim 1, wherein outputting the indication of the potential microloop condition comprises:
transmitting the indication from the node to other nodes on the ring.

9. The method of claim 1, wherein convergence of the network is performed using a link state protocol.

10. An apparatus, comprising:
one or more processors; and
memory storing instructions that, when executed by the one or more processors, cause the apparatus to:
obtain a topology for a network comprising a set of nodes connected by a set of links;
use the topology to detect a ring comprising at least four hops in the network; and
output an indication of a potential microloop condition associated with one or more nodes on the ring to improve routing of network traffic by the one or more nodes.

11. The apparatus of claim 10, wherein using the topology to detect the ring comprises:
removing a link between the node and another node in the topology;
calculating, based on the removed link, an alternative path between the node and the other node; and
detecting the ring when the alternative path comprises more than two hops.

12. The apparatus of claim 10, wherein the memory further stores instructions that, when executed by the one or more processors, cause the apparatus to:
obtain, based on the potential microloop condition, one or more loop-free alternate (LFA) paths for the node to another node on the ring; and
store the one or more LFA paths as backup paths between the node and the other node.

13. The apparatus of claim 12, wherein the memory further stores instructions that, when executed by the one or more processors, cause the apparatus to:
use the one or more LFA paths to route network traffic between the node and the other node when a failure in a link between the node and the other node is detected.

14. The apparatus of claim 13, wherein the one or more LFA paths comprise at least one of:
a local LFA; and
a remote LFA.

15. The apparatus of claim 10, wherein outputting the indication of the potential microloop condition comprises:
assigning the potential microloop condition to all nodes on the ring.

16. The apparatus of claim 10, wherein outputting the indication of the potential microloop condition comprises:
transmitting the indication from the node to other nodes on the ring.

17. A system, comprising:
a network comprising a set of nodes connected by a set of links; and
a node in the set of nodes, wherein the node comprises a non-transitory computer-readable medium comprising instructions that, when executed, cause the system to:
obtain a topology for the network;
use the topology to detect a ring comprising at least four hops in the network; and
output an indication of a potential microloop condition associated with one or more nodes on the ring to improve routing of network traffic by the one or more nodes.

18. The system of claim 17, wherein using the topology to detect the ring comprises:
removing a link between the node and another node in the topology;
calculating, based on the removed link, an alternative path between the node and the other node; and
detecting the ring when the alternative path comprises more than two hops.

19. The system of claim 17, wherein outputting the indication of the potential microloop condition comprises:
assigning the potential microloop condition to all nodes on the ring.

20. The system of claim 17, wherein outputting the indication of the potential microloop condition comprises:
transmitting the indication from the node to other nodes on the ring.
